(19) United States
(12) Patent Application Publication
(10) Pub. No.: US 2018/0130371 A1
(43) Pub. Date: May 10, 2018

(54) DIGITAL MUSIC READING SYSTEM AND METHOD

(71) Applicant: Bradley Haber, Hollywood, FL (US)

(72) Inventor: Bradley Haber, Hollywood, FL (US)

(21) Appl. No.: 15/646,060

(22) Filed: Jul. 10, 2017

Related U.S. Application Data
(60) Provisional application No. 62/419,858, filed on Nov. 9, 2016.

(51) Int. Cl. G09B 15/00; G06F 3/01; G02B 27/01; G09B 5/02

(52) U.S. Cl. CPC G09B 15/00; G06F 3/013; G02B 2027/0178; G02B 27/0176; G09B 5/02; G06F 3/012

(57) ABSTRACT

A eyewear assembly is disclosed herein. The eyewear assembly includes an eyeglasses frame, a pair of eyeglass lenses configured to display information, a controller, at least one sensor, and a power supply. The eyewear assembly is useful for digital eyewear useful for efficiently reading sheet music whilst simultaneously playing a musical instrument.

### CROSS REFERENCE TO RELATED APPLICATION

The present application is related to and claims priority to U.S. Provisional Patent Application No. 62/419,858 filed Nov. 9, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. FIELD OF THE INVENTION

The present invention relates generally to the field of eyewear and more specifically relates to digital eyewear.

### 2. DESCRIPTION OF RELATED ART

Sheet music is a printed form of music notation that uses musical symbols to indicate the pitches, rhythms and chords of a song or instrumental musical piece. To read sheet music, a musician typically must sift through pages of a paperbook whilst simultaneously playing their instrument. This takes attention away from playing the instrument and may be difficult for some people, especially individuals learning how to play music for the first time. Maintaining focus on hand and finger positioning can be exceptionally difficult if an individual is forced to read sheet music from a physical page simultaneously.

U.S. Pat/Pub. No. 20150053067 to Michael Goldstein relates to a providing musical lyrics and musical sheet notes through digital eyewear. The described providing musical lyrics and musical sheet notes through digital eyewear includes an optical device for presenting music information. The optical device identifies an indication that a music piece is to begin playback. The optical device identifies music information associated with the music piece. The optical device presents the music information in synchronization with playback of the music piece.

### BRIEF SUMMARY OF THE INVENTION

In view of the foregoing disadvantages inherent in the known digital eyewear art, the present disclosure provides a novel digital music reading system and method. The general purpose of the present disclosure, which will be described subsequently in greater detail, is to provide digital eyewear useful for efficiently reading sheet music whilst simultaneously playing a musical instrument.

An eyewear assembly is disclosed herein. The eyewear assembly may include an eyeglasses frame having a frame front, a hinged left temple and a hinged right temple, a pair of eyeglass lenses affixed to the eyeglass frame, and including a digital display configured to display information. A controller may be fixed to the eyeglasses frame, and may be communicably coupled with the digital display. The controller may include a memory configured to store the information, a processor configured to display the information on the digital display, and a wireless transceiver configured to wirelessly communicably couple with at least one electronic device remote from the eyeglasses frame. At least one sensor may be fixed to the eyeglasses frame, and communicably coupled with the processor, and configured to detect motion. Further, a power supply may be affixed to the frame member, and configured to supply power to the controller and the digital display.

A method of using eyewear assembly is also disclosed herein. The method of using eyewear assembly may comprise the steps of: securing the eyewear assembly to a head, wirelessly communicably coupling an electronic device remote from the eyewear assembly to the wireless transceiver in the eyewear assembly, selecting music information from the electronic device to display, displaying the selected music information on the digital, reading the selected music information displayed on the digital display while simultaneously playing a musical instrument, shaking the head to change the music information displayed on the digital display, and changing the music information displayed on the digital display in response to the shaking the head. The method may further include the steps of downloading the music information from the electronic device, and storing the music information onto a memory of the eyeglass assembly.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a digital music reading system and method, constructed and operative according to the teachings of the present disclosure.

FIG. 1 is a side perspective view of the eyewear assembly of FIG. 1 during an ‘in-use’ condition, according to an embodiment of the present disclosure.

FIG. 2 is a front perspective view of the eyewear assembly, according to an embodiment of the disclosure.

FIG. 3A is a detail view of a digital display of the eyewear assembly of FIG. 1, according to an embodiment of the present disclosure.

FIG. 3B is a detail view of a digital display of the eyewear assembly of FIG. 1, according to an embodiment of the present disclosure.

FIG. 4 is a back-side perspective view of the eyewear assembly of FIG. 1, according to an embodiment of the present disclosure.

FIG. 5 is a flow diagram illustrating a method of use for eyewear assembly, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to eyewear and more particularly to a digital music reading system and method as used to improve digital eyewear for reading music information.

Generally, disclosed is a pair of electronic eyeglasses which may be useful for allowing a musical instrument player to read sheet music through a digital display without having to turn physical pages. The simple blinking of an eye or shake of a head may turn the page on the music eyeglasses, thus not disturbing the flow of the music playing. The glasses may allow a user to instantly download a particularly song and save it to their music library and receive instruction in order to assist the user in certain chords of a song. The music glasses may also include wireless capabilities to allow them to connect to a mobile phone application. The music glasses may be produced in a number of styles and colors.

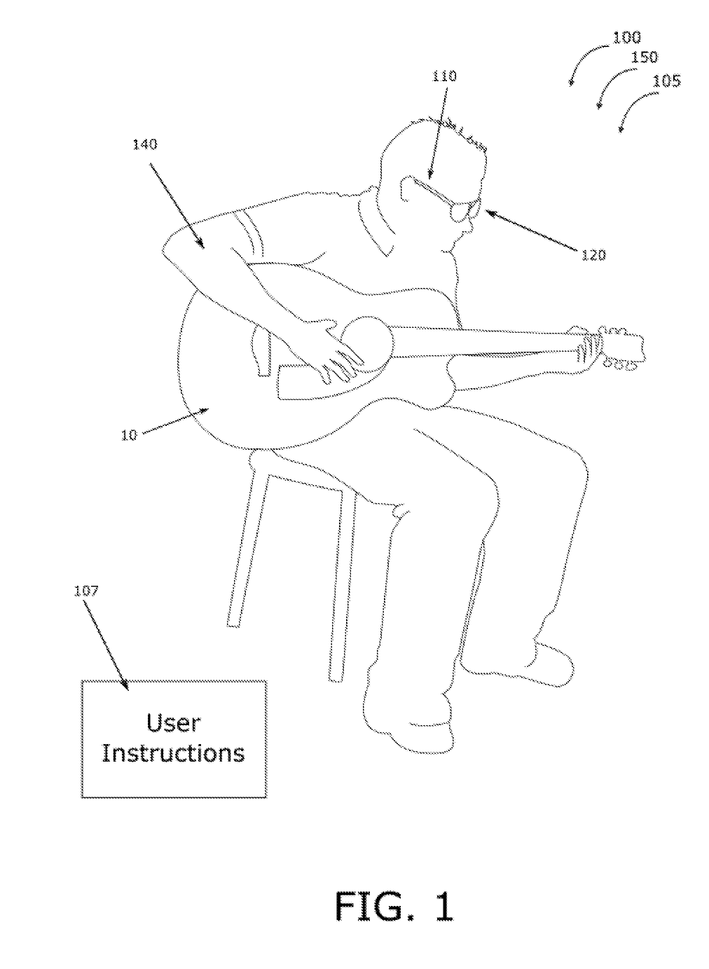

Referring now more specifically to the drawings by numerals of reference, there is shown in FIGS. 1-4, various views of an eyewear assembly 100.

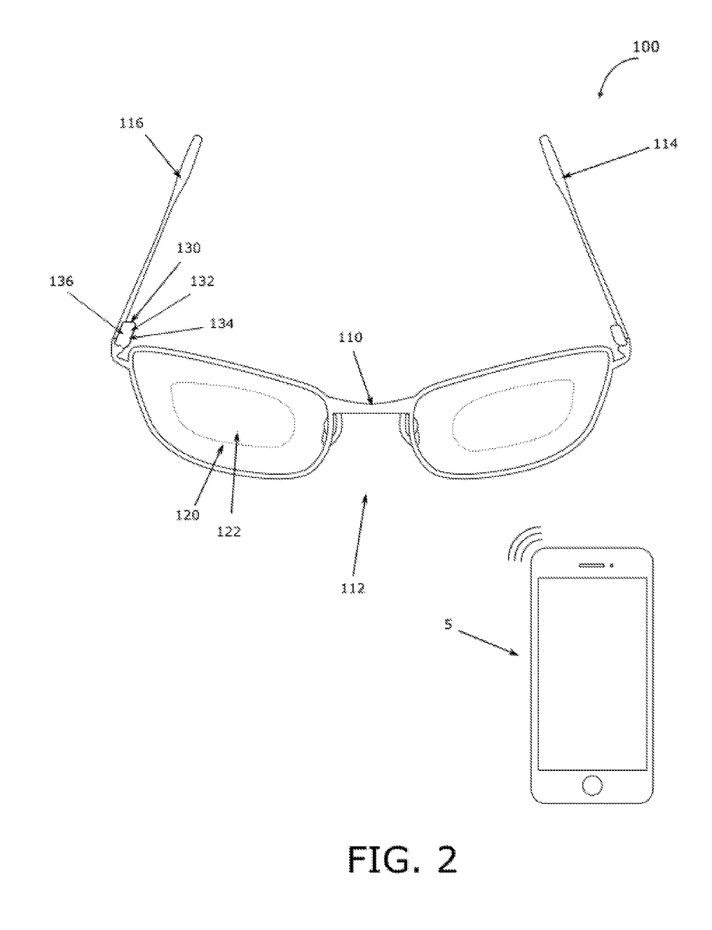

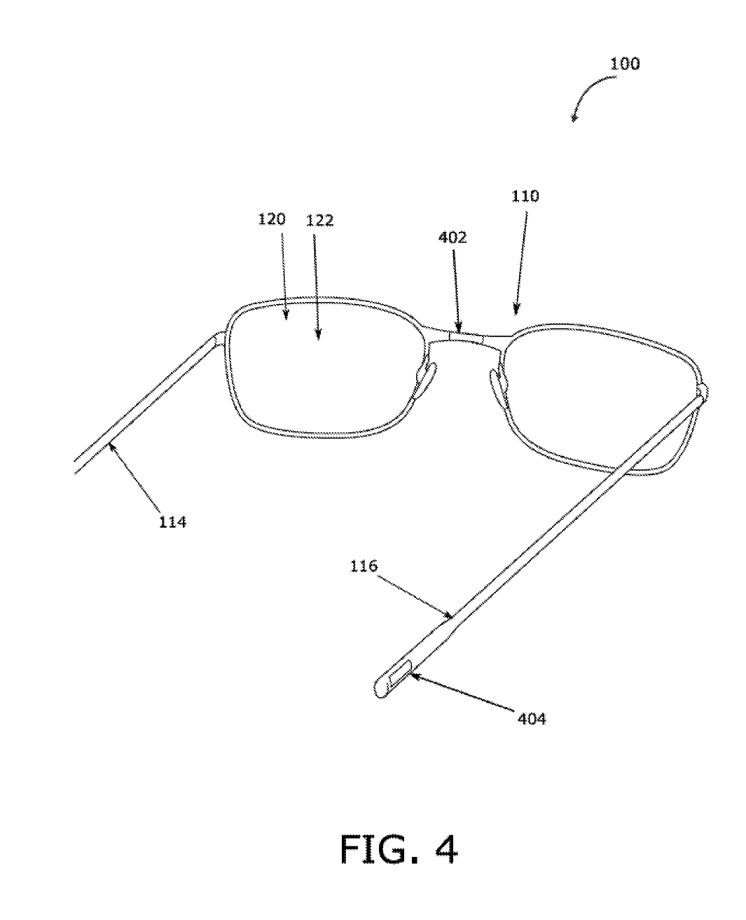

FIG. 1 shows a side perspective view of the eyewear assembly 100 during an ‘in-use’ condition 150, according to an embodiment of the present disclosure. Demonstrated here, is the user 140 wearing the eyewear assembly 100 whilst simultaneously playing a musical instrument 10. As shown, the eyewear assembly 100 may include an eyeglasses frame 110, a pair of eyeglass lenses 120, a controller 130 (FIG. 2), at least one sensor 402 (FIG. 4), and a power supply 404 (FIG. 4). In one embodiment, the pair of eyeglass lenses 120 may be nonprescription lenses. Alternatively, in a further embodiment, the pair of eyeglass lenses 120 may be prescription lenses which would allow a user 140 to use the eyeglass assembly for sight when the digital display 122 is not in use.

According to one embodiment, the eyewear assembly 100 may be arranged as a kit 105. In particular, the eyewear assembly 100 may further include a set of instructions 107. The instructions 107 may detail functional relationships in relation to the structure of the eyewear assembly 100 such that the eyewear assembly 100 can be used, maintained, or the like, in a preferred manner.

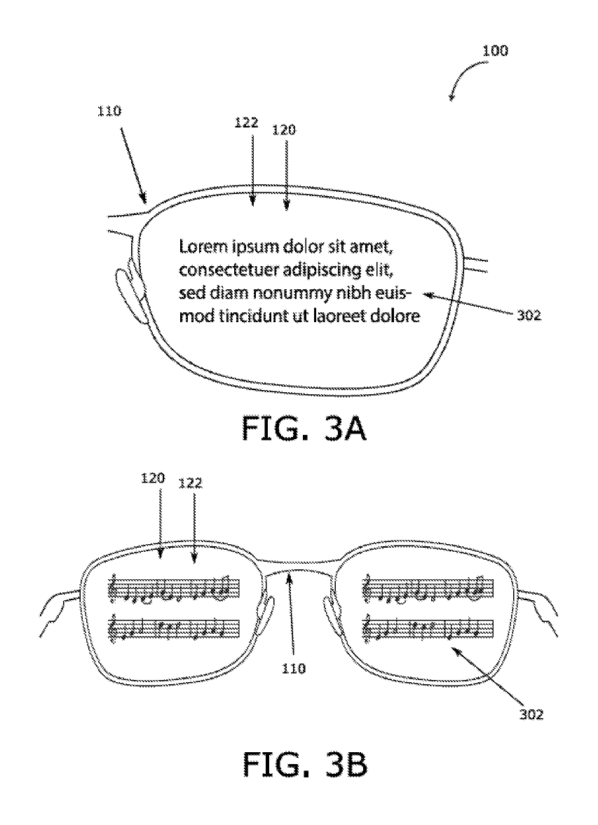

FIG. 2 shows an eyewear assembly 100 according to an embodiment of the present disclosure. As illustrated, the eyewear assembly 100 may include an eyeglasses frame 110 having a frame front 112, a hinged left temple 114 and a hinged right temple 116, a pair of eyeglass lenses 120 affixed to the eyeglass frame 110, and including a digital display 122 configured to display information 302 (FIG. 3A). In the preferred embodiment, the digital display 122 may include a heads-up display (HUD). The HUD may include a projection unit for projecting the information 302 and a combiner composed of a transparent piece of glass and configured to project the information 302 so as to allow a user to view the information 302 and their field of view (their musical instrument 10) simultaneously. The eyeglasses frame 110 may further include a projector for projecting the information 302 onto a surface remote of the eyewear assembly 100.

According to one embodiment, the controller 130 may be embedded in, or otherwise fixed to the eyeglasses frame 110, and may be communicably coupled with the digital display 122. Further, a power supply 404 (FIG. 4) may be embedded in, or otherwise affixed to the frame member, and configured to supply power to the controller 130 and the digital display 122.

As above, the controller 130 may include a memory 132 configured to store the information 302 (FIG. 3), a processor 134 configured to display the information 302 on the digital display 122, and a wireless transceiver 136 configured to wirelessly communicably couple with at least one electronic device 5 remote from the eyeglasses frame 110. In one embodiment, the controller 130 may be or include a single integrated circuit (IC) chip located within the eyeglasses frame 110. The processor 134 on the IC chip may be a central processing unit (CPU) that carries out an instruction set to perform basic arithmetic, logical, control and input/output (I/O) operations specified by the instruction set.

The memory 132 may include a flash memory for storage of the information 302 thereon, and a random-access memory (RAM) for storage of the instruction set. The memory 132 may include a non-transitory computer-readable storage medium that stores instructions for execution by the controller 130 and data, such as received image data and generated display data.

The controller 130 may, by executing the instructions stored by the memory 132, generate display data for presentation. It should be noted that the processor 134 suitable for the execution of a computer program may include both general- and special-purpose microprocessors, and at least one processor 134 of any kind of digital computer. Generally, the processor 134 will receive instructions and data from a read-only memory or a random access memory or both. Elements of a digital computer may include at least one processor 134 for executing instructions and one or more memory 132 for storing instructions and data. Those with ordinary skill in the art will now appreciate that upon reading this specification and by their understanding the art of processing, memory storage and retrieval, and display as described herein, methods of implementing processing and controlling means will be understood by those knowledgeable in such art.

At least one sensor 402 (FIG. 4) may be embedded in, or otherwise fixed to the eyeglasses. The at least one sensor 402 may be an accelerometer. The accelerometer may include two orthogonal sensors capable of sensing pitch and roll to detect a tilt of the head. The accelerometer may further include an output range of at least ±1.5 g and a bandwidth of at least 40 Hz.

In the preferred embodiment, the at least one sensor 402 may include two sensors. One sensor may be the accelerometer. The other sensor may be an optical sensor. Infrared may be reflected from the eye and sensed by the optical sensor. When the optical sensor detects eye movement, a digital signal may be sent to the processor 134 to change the information 302 on the digital display 122. Similarly, when the accelerometer detects head movement, a digital signal may be sent to the processor 134 to also change the information 302 on the digital display 122. Those with ordinary skill in the art will now appreciate that upon reading this specification and by their understanding the art of sensing means as described herein, methods of sensing will be understood by those knowledgeable in such art. The accelerometer and optical sensor discussed herein are to be understood to be provided for exemplary means for enablement and that they are not to be considered so as to in any way limit the scope of the present invention and that other suitably equivalent sensing means may be used.

The processor 134 may be configured to display the information 302 on the digital display 122 upon receipt of a signal from the at least one sensor 402 that motion is detected. The wireless transceiver 136 may be configured for Bluetooth wireless connectivity and Wi-Fi wireless connectivity. Further, the controller 130 may be configured to communicably couple with an external source via Wi-Fi, download the information 302 from the external source, and store the information 302 in the memory 132. The processor 134 may further be configured to change the information 302 on the digital display 122 upon receipt of a signal from the at least one sensor 402.

In the preferred embodiment, the eyeglass frame 110 and a pair of eyeglass lenses 120 affixed to the eyeglass frame and including a digital display 122 configured to display music information 302. Further, the controller 130 may be fixed to the eyeglass frame, and communicably coupled with the digital display 122. The controller 130 may be fixed to an external surface of the eyeglass frame or disposed within an internal surface of the eyeglass frame. The controller 130 may include a memory 132 configured to store the music information 302, a processor 134 configured to display the music information 302 on the digital display 122, and a wireless transceiver 136 configured to wirelessly communicably couple with at least one electronic device 5 remote from the eyeglasses frame 110. The electronic device 5 may be a smartphone, a tablet computer, a laptop computer, and the like.

In this preferred embodiment, the processor 134 may be configured to display the music information 302 on the digital display 122 upon receipt of a signal from the at least one sensor 402 that motion is detected. Further, the wireless transceiver 136 may be configured for Wi-Fi wireless connectivity, and the controller 130 may be configured to communicably couple with an external source via Wi-Fi, download the music information 302 from the external source, and store the music information 302 in the memory 132. The music information 302 may include sheet music. In a further example, the music information 302 may include music chord information 302.

FIG. 3A shows a back perspective view of the eyewear assembly 100 of FIG. 1, according to an embodiment of the present disclosure. Illustrated here is information 302 shown on the digital display 122 of the eyeglass lenses 120. As above, the eyewear assembly 100 may include an eyeglasses frame 110 having a frame front 112, a hinged left temple 114 and a hinged left temple 114 (FIG. 1), a pair of eyeglass lenses 120 affixed to the eyeglass frame, and including a digital display 122 configured to display information 302.

The information 302 may include electronic book text. In this regard, the eyewear assembly 100 may be used for reading an e-book, e-magazine, or the like. Further, the information 302 may include electronic speech text. In this regard, the eyeglass assembly may act as a teleprompter for the user 140 such that the user 140 may read a speech from the digital display 122 of the eyeglass lenses 120.

FIG. 3B shows a back perspective view of the eyewear assembly 100 of FIG. 1, according to the preferred embodiment of the present disclosure. Illustrated here is the music information 302 shown on the digital display 122 of the eyeglass lenses 120. In a preferred embodiment, the information 302 may include sheet music. In a further example, the information 302 may include music chord information 202. Similarly, a further example may include instructions for playing a musical instrument 10.

FIG. 4 shows a back-side view of the eyewear assembly 100 of FIG. 1, according to an embodiment of the present disclosure. Shown here is the at least one sensor 402 and the power supply 404 affixed to the eyeglass frame 110. The at least one sensor 402 may include two motion sensors that may be configured to detect an eye movement/command and configured to detect a head movement, respectively. The eye movement may be a blink of an eye, and the head movement may be a shake of a head.

In the preferred embodiment, the processor 134 (FIG. 2) may be configured to display the music information 302 (FIG. 3) on the digital display 122 upon receipt of a signal from the at least one sensor 402 that motion is detected. The processor 134 may further be configured to change the music information 302 on the digital display 122 upon receipt of a signal from the at least one sensor 402. For example, the processor 134 may change a page of a music sheet book upon detection of the shake of the head or the blink of the eye by the at least one sensor 402.

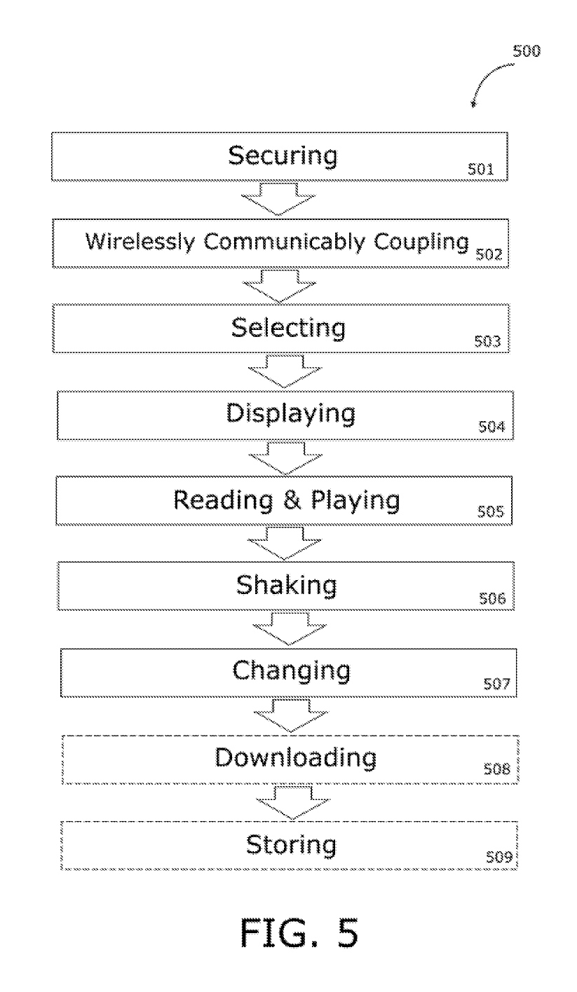

FIG. 5 is a flow diagram illustrating a method for using an eyewear assembly 500, according to an embodiment of the present disclosure. As illustrated, the method for using an eyewear assembly 500 may include the steps of: step one 501, securing the eyewear assembly 100 to a head (as discussed above, the eyewear assembly 100 may include a wireless transceiver 136 in the eyewear assembly 100, a digital display 122, and a memory 132); step two 502, wirelessly communicably coupling an electronic device remote from the eyewear assembly 100 to the wireless transceiver 136 in the eyewear assembly 100; step three 503, selecting music information 302 from the electronic device to display; step four 504, displaying the selected music information 302 on the digital display 122; step five 505, reading the selected music information 302 displayed on the digital display 122 while simultaneously playing a musical instrument; step six 506, shaking the head to change the music information 302 displayed on the digital display 122; and step seven 507, changing the music information 302 displayed on the digital display 122 in response to the shaking the head. The method may further comprise the steps of: step eight 508, downloading the music information 302 from the electronic device; and step nine 509, storing the music information 302 onto the memory 132 of the eyeglass assembly.

It should be noted that steps eight 508 and nine 509 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for eyewear assembly 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms of phraseology, to determine quickly from a cursory inspection the nature and essence of the technical disclosure of the application.

What is claimed is new and desired to be protected by Letters Patent is set forth in the appended claims:

1. An eyewear assembly comprising:
an eyeglasses frame having a frame front, a hinged left temple and a hinged right temple;
a pair of eyeglass lenses affixed to the eyeglass frame, and including a digital display configured to display information;
a controller fixed to the eyeglasses frame, and communicably coupled with the digital display, the controller including
a memory configured to store the information,
a processor configured to display the information on the digital display, and
a wireless transceiver configured to wirelessly communicably couple with at least one electronic device remote from the eyeglasses frame;
at least one sensor fixed to the eyeglasses frame, and communicably coupled with the processor, the at least one sensor configured to detect motion; and
a power supply affixed to the frame member, and configured to supply power to the controller and the digital display.

2. The eyewear assembly of claim 1, wherein the processor is configured to display the information on the digital display upon receipt of a signal from the at least one sensor that motion is detected.

3. The eyewear assembly of claim 2, wherein the at least one sensor includes two motion sensors.

4. The eyewear assembly of claim 3, wherein at least one of the two motion sensors is configured to detect an eye movement.

5. The eyewear assembly of claim 4, wherein the eye movement is a blink of an eye.

6. The eyewear assembly of claim 3, wherein at least one of the two motion sensors is configured to detect a head movement.

7. The eyewear assembly of claim 6, wherein the head movement is a shake of a head.

8. The eyewear assembly of claim 1, wherein the processor is configured to change the information on the digital display upon receipt of a signal from the at least one sensor.

9. The eyewear assembly of claim 1, wherein the wireless transceiver is further configured for Bluetooth wireless connectivity.

10. The eyewear assembly of claim 1, wherein the wireless transceiver is further configured for Wi-Fi wireless connectivity.

11. The eyewear assembly of claim 10, wherein the controller is configured to communicably couple with an external source via Wi-Fi, download the information from the external source, and store the information in the memory.

12. The eyewear assembly of claim 1, wherein the pair of eyeglass lenses are nonprescription lenses.

13. The eyewear assembly of claim 1, wherein the pair of eyeglass lenses are prescription lenses.

14. The eyewear assembly of claim 1, wherein the information includes sheet music.

15. The eyewear assembly of claim 14, wherein the information further includes electronic book text.

16. The eyewear assembly of claim 15, wherein the information further includes electronic speech text.

17. An eyewear assembly comprising:
an eyeglasses frame having a frame front, a hinged left temple and a hinged right temple;
a pair of eyeglass lenses affixed to the eyeglass frame, and including a digital display configured to display music information;
a controller fixed to the eyeglasses frame, and communicably coupled with the digital display, the controller including
a memory configured to store the music information,
a processor configured to display the music information on the digital display, and
a wireless transceiver configured to wirelessly communicably couple with at least one electronic device remote from the eyeglasses frame;
at least one sensor fixed to the eyeglasses frame, and communicably coupled with the processor, the at least one sensor configured to detect motion; and
a power supply affixed to the frame member, and configured to supply power to the controller and the digital display; and
wherein the processor is configured to display the music information on the digital display upon receipt of a signal from the at least one sensor that motion is detected;
wherein the at least one sensor includes two motion sensors;
wherein at least one of the two motion sensors is configured to detect an eye movement;
wherein the eye movement is a blink of an eye;
wherein at least one of the two motion sensors is configured to detect a head movement;
wherein the head movement is a shake of a head;
wherein the processor is configured to change the music information on the digital display upon receipt of a signal from the at least one sensor;
wherein the wireless transceiver is further configured for Wi-Fi wireless connectivity;
wherein the controller is configured to communicably couple with an external source via Wi-Fi, download the information from the external source, and store the information in the memory;
wherein the pair of eyeglass lenses are nonprescription lenses;
wherein the music information includes sheet music; and
wherein the music information further includes music chord information.

18. The eyewear assembly of claim 17, further comprising set of instructions; and
wherein the eyewear assembly is arranged as a kit.

19. A method for using an eyewear assembly, the method comprising the steps of:
securing the eyewear assembly to a head, the eyewear assembly including a wireless transceiver in the eyewear assembly, a digital display, and a memory;
wirelessly communicably coupling an electronic device remote from the eyewear assembly to the wireless transceiver in the eyewear assembly;
selecting music information from the electronic device to display;
displaying the selected music information on the digital;
reading the selected music information displayed on the digital display while simultaneously playing a musical instrument;
shaking the head to change the music information displayed on the digital display; and
changing the music information displayed on the digital display in response to the shaking the head.

20. The method of claim 19, further comprising the steps of:
downloading the music information from the electronic device; and
storing the music information onto the memory of the eyeglass assembly.
